(19) United States
(12) Patent Application Publication
(10) Pub. No.: US 2026/0278458 A1
(43) Pub. Date: Sep. 17, 2026

(54) TRAINING A MACHINE-LEARNING MODEL FOR USE IN A RADIO ACCESS NETWORK CONTROLLER

(71) Applicant: NEC Laboratories Europe GmbH, Heidelberg (DE)

(72) Inventors: Lanfranco ZANZI, Heidelberg (DE); Francesco DEVOTI, Heidelberg (DE); Andres GARCIA-SAAVEDRA, Heidelberg (DE); Xi LI, Heidelberg (DE); Linghang FAN, Heidelberg (DE)

(21) Appl. No.: 19/168,824

(22) PCT Filed: Nov. 7, 2023
(86) PCT No.: PCT/EP2023/081049

§ 371 Date: Sep. 25, 2025

(30) Foreign Application Priority Data
Jun. 16, 2023 (EP) 23179810

(51) Int. Cl. G06N 20/00; H04W 8/00; H04W 84/04

(52) U.S. Cl. CPC G06N 20/00; H04W 8/00; H04W 84/042

(57) ABSTRACT

A method for training a machine-learning model for use in a Radio Access Network (RAN) controller of a wireless communication network includes receiving, by a brokering entity from the RAN controller, a request for training the machine-learning model. The method includes triggering, by the brokering entity, an assignment of computational resources of a shared hardware accelerator device being separate from the RAN controller for a training application to be used for training the machine-learning model. The method includes training, by the training application and using the assigned computational resources, the machine learning model, and providing the trained machine learning-model to the RAN controller. The method has applications including, but not limited to, Artificial Intelligence (AI) and Machine Learning (ML) operations for optimizing training of a machine-learning model (e.g., a neural network) for use in a RAN controller with improved decision making.

### CROSS REFERENCE TO RELATED APPLICATIONS

This application is a U.S. National Phase application under 35 U.S.C. § 371 of International Application No. PCT/EP 2023/081049, filed on Nov. 7, 2023, and claims benefit to European Patent Application No. 23179810.9, filed on Jun. 16, 2023. The International Application was published in English on Dec. 19, 2024 as WO 2024/256032 A1 under PCT Article 21(2).

### STATEMENT REGARDING SPONSORED RESEARCH OR DEVELOPMENT

The project leading to this application has received funding from the European Union's Horizon 2020 research and innovation programme under grant agreement No. 101017109.

### FIELD

The present invention relates to a method for training a machine-learning model for use by a Radio Access Network (RAN) controller of a wireless communication network, to a wireless communication network, and to a brokering entity for a wireless communication network and corresponding method and computer program.

### BACKGROUND

Machine learning is field of research that focuses on the development of algorithms and models that allow computers to learn and make predictions or decisions without being explicitly programmed. Instead of being explicitly programmed, machines are trained on large amounts of data to recognize patterns and make accurate predictions or decisions.

Machine learning is being applied in many fields, including wireless communication networks. While machine learning enables new types of analytics and control loops, the use of machine learning is hampered by the large amount of resources being require for training a machine-learning model. While many devices or network entities have sufficient resources to perform inference, i.e., to use a machine-learning model, the training of such a model is often out of scope of these devices, as the training of such models is computationally expensive and often requires more volatile memory than is available at the devices being used for inference.

### SUMMARY

In an embodiment, the present disclosure provides a method for training a machine-learning model for use in a Radio Access Network (RAN) controller of a wireless communication network includes receiving, by a brokering entity from the RAN controller, a request for training the machine-learning model. The method includes triggering, by the brokering entity, an assignment of computational resources of a shared hardware accelerator device being separate from the RAN controller for a training application to be used for training the machine-learning model. The method includes training, by the training application and using the assigned computational resources, the machine learning model, and providing the trained machine learning-model to the RAN controller. The method has applications including, but not limited to, Artificial Intelligence (AI) and Machine Learning (ML) operations for optimizing training of a machine-learning model (e.g., a neural network) for use in a RAN controller with improved decision making.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic diagram of an architecture of infrastructure elements of a wireless communication network according to the O-RAN specification;

FIG. 2 shows a schematic diagram of an implementation of an AI/ML enabler in a O-RAN Non-RT RIC;

FIG. 3 shows a high-level overview of an Acceleration Abstraction Layer (AAL);

FIG. 4 shows a high-level overview of an architecture, in which the AAL is used;

FIG. 5 shows a flow chart of an example of a method for training a machine-learning model for use in a RAN controller according to embodiments of the present disclosure;

FIG. 6 shows an example of an extended architecture, in which the AAL is used;

FIG. 7a shows an example of a workflow for rApp ML model training in the Non-RT RIC;

FIG. 7b shows an example of a workflow for rApp ML model training in the O-Cloud;

FIG. 8a shows an example of a workflow for xApp ML model training in the Near-RT RIC;

FIG. 8b shows an example of a workflow for xApp ML model training in the O-Cloud;

FIG. 9 shows a proposed workflow for rApp ML model training in the O-Cloud and local data processing pipeline setup; and

FIG. 10 shows an example of an rApp ML model training and related data processing pipeline in the O-Cloud.

### DETAILED DESCRIPTION

Embodiments of the present disclosure provide improvements to the use of machine learning in wireless communication networks. Various examples of the present disclosure are based on the finding, that, in wireless communication networks, computing infrastructure exists that can be reused to offload the training of machine-learning models. For example, in wireless communication networks according to the Open RAN (O-RAN) specification, the so-called O-Cloud (O-RAN Cloud) is a set of hardware and software accelerators that provide cloud computing capabilities for executing various RAN functions on heterogeneous hardware accelerators. According to the specification, these cloud computing capabilities are provided for use by the so-called Distributed Units (O-DUs) and for the Central Unit (O-CU). In addition, the use of machine learning is specified for two levels of RAN controllers of the wireless communication network, the O-RAN Near-Real-Time RAN Intelligent Controller (Near-RT RIC), and the O-RAN Non-Real-Time RAN Intelligent Controller (Non-RT RIC). However, according to the present specification, these controllers are not allowed to offload computing tasks to the O-Cloud, as the computing capabilities are reserved for the O-DUs and O-CU. In embodiments of the present disclosure, a brokering entity is introduced that is used to determine the availability of computational resources at the shared accelerator, and to assign computational resources for a training application being used to train the machine-learning model that is to be used at the RAN controller, such as the Near-RT RIC or the Non-RT RIC. This way, the respective RAN controllers can be implemented with fewer computational resources or can be enabled to use machine-learning models that have been trained with a higher computational effort.

Some aspects of the present disclosure relate to a method for training a machine-learning model for use in a Radio Access Network (RAN) controller of a wireless communication network. The method comprises receiving, by a brokering entity from the RAN controller, a request for training a machine-learning model. The method comprises triggering, by the brokering entity, an assignment of computational resources of a shared hardware accelerator device being separate from the RAN controller for a training application to be used for training the machine-learning model. The method comprises training, by the training application and using the assigned computational resources, the machine-learning model. The method comprises providing the trained machine-learning model to the RAN controller. This way, the training of the machine-learning model is offloaded from the RAN controller, such that the RAN controller can be implemented with fewer computational resources or can be enabled to use machine-learning models that have been trained with a higher computational effort.

For example, the shared hardware accelerator device may be a shared hardware accelerator device used for accelerating at least one function of at least one of a central unit of the wireless communication network and one or more distributed units of the wireless communication network. This way, the shared hardware accelerator device can be re-used for the purpose of training the machine-learning model, which may reduce the overall costs of implementing the wireless communication network.

In various examples, the at least one function of the central unit and/or the one or more distributed units are prioritized over the training of the machine-learning model during assignment of the computational resources. In effect, the real-time operation of the wireless communication network may be prioritized, such that operation of the wireless communication network is not impeded by the training of the machine-learning model.

For example, the wireless communication network may be a wireless communication network according to the Open RAN, O-RAN, specification. In such a wireless communication network, the shared hardware accelerator device may be associated with a O-RAN Cloud (O-Cloud) of the wireless communication network. Thus, existing computational resources of the O-Cloud may be re-used for training the machine-learning model.

As outlined above, the wireless communication network may be a wireless communication network according to the Open RAN, O-RAN, specification. In this case, the RAN controller may be one of a O-RAN Near-Real-Time RAN Intelligent Controller and a O-RAN Non-Real-Time RAN Intelligent Controller. These RAN controllers support the use of machine-learning/artificial intelligence and would therefore benefit from the offloading of the training of the machine-learning model.

In some examples, triggering assignment of the computational resources may comprise selecting or triggering creation of a Logical Processing Unit (LPU) based on the request for training the machine-learning model and based on available computational resources of the shared hardware accelerator device. For example, the machine-learning model may be trained using the LPU. The LPU may be selected or created such, that it is suitable for training the machine-learning model while avoiding starving the use of the shared hardware accelerator device for real-time processing.

In some examples, the method may comprise selecting or triggering creation of, by the brokering entity, a pre-defined LPU according to a machine-learning model-independent template. This way, a LPU may be created without detailed knowledge of the requirements of the machine-learning model being trained, which may reduce the implementation complexity.

In some examples, the method may comprise triggering, by the brokering entity, creation of a custom LPU for the machine-learning model to be trained. This way, the resulting LPU can be improved or optimized with a specific machine-learning model in mind, which can result in an improved training performance.

In wireless communication networks according to the O-RAN specification, so-called Acceleration Abstraction Layer (AAL) profiles are used to define accelerated functions that are then being provided by the shared hardware accelerator device. For example, the shared hardware accelerator device may be accessible via the AAL. Accordingly, the training of the machine-learning model may be based on an AAL profile, with the AAL profile specifying the training application with one or more accelerated functions (including the training) to be processed by the shared hardware accelerator device on behalf of the RAN controller. For example, the one or more accelerated functions comprising the training of the machine-learning model. AAL profiles are bundles that are used to define applications to be executed using the shared hardware accelerator device. They can be executed on a shared hardware accelerator device across different shared hardware accelerator devices, so that the training application can be run, without modification, on different types of shared hardware accelerator devices. This can make scheduling executing the training application easier, as the training application is not tied to a specific hardware.

In some examples, the method may comprise selecting or creating, by the brokering entity, a pre-defined AAL profile according to a machine-learning model-independent template and based on the request for training the machine-learning model. By using a pre-defined AAL profile, an implementation complexity may be reduced.

In an embodiment of the present disclosure, the method may comprise creating, by the brokering entity, a custom AAL profile for the machine-learning model to be trained based on the request for training the machine-learning model. This way, the AAL profile may be improved or optimized for the specific machine-learning model, which may improve the performance of the training, while being more complex to implement.

According to an example, creating the respective AAL profile may comprise at least one of translating the machine-learning model into a format suitable for the AAL profile, selecting a driver for using the assigned computational resources, and selecting a software library for using the assigned computational resources. These types of tasks may be used for preparing the training of the machine-learning model on an arbitrary shared hardware accelerator device.

In some examples, the method may comprise obtaining, by the training application and based on the request, data to be used for training the machine-learning model from at least one other entity of the wireless communication network. In other words, the training data may be obtained directly (or indirectly) from the source of the data (being separate from the RAN controller), instead of being provided by the RAN controller. This may reduce the load of the RAN controller, as it does not have to act as intermediary for providing the training data.

According to an example, the data to be used for training the machine-learning model may be obtained from at least one distributed unit of the wireless communication network. The data provided by distributed units of the wireless communication network is a valuable input of a machine-learning-based control loop being performed by the RAN controller.

In some examples, the method may comprise pre-processing, by a pre-processing application being executed using computational resources of the shared hardware accelerator, the data to be used for training the machine-learning model, with the pre-processed data being used for training the machine-learning model. This way, the data can be prepared in situ, without going through the RAN controller, which may also reduce the load of the RAN controller, as it does not have to act as intermediary for providing the training data.

Some aspects of the present disclosure relate to a wireless communication network. The wireless communication network comprises a RAN controller, a shared hardware accelerator device being separate from the RAN controller, and a brokering entity. The RAN controller is configured to provide a request for training a machine-learning model to the brokering entity. The brokering entity is configured to trigger an assignment of computational resources of the shared hardware accelerator device for a training application to be used for training the machine-learning model. The shared hardware accelerator device is configured to execute the training application. The RAN controller is configured to obtain the trained machine-learning model from the training application. This way, the training of the machine-learning model is offloaded from the RAN controller, such that the RAN controller can be implemented with fewer computational resources or can be enabled to use machine-learning models that have been trained with a higher computational effort.

The wireless communication network further may further comprise a hardware accelerator manager. For example, the brokering entity may be configured to trigger the assignment of the computational resources via the hardware accelerator manager. For example, the hardware accelerator manager may be used to define Logical Processing Units (LPUs), which may represent the assigned computational resources, and to upload Acceleration Abstraction Layer profile, which may represent the training application.

For example, the shared hardware accelerator device may be associated with a cloud component of the wireless communication network. This way, an existing cloud component (e.g., the O-Cloud) may be re-used for the purpose of training the machine-learning model.

In some examples, the wireless communication network may comprise a first communication interface configured to connect the RAN controller to at least one of a central unit, a distributed unit, and a radio unit of the wireless communication network. The wireless communication network may further comprise a second communication interface configured to connect the RAN controller to the brokering entity. The second communication interface may thus be used to configure the shared hardware accelerator device, while the first communication interface may be used for the operation and interaction of the RAN controller and the various infrastructure elements (central unit, distributed units and radio units) of the wireless communication network.

For example, the first communication interface may be further configured to connect at least one of the central unit, the distributed unit, and the radio unit to the training application, with the training application being configured to obtain data for training the machine-learning model via the first communication interface. This way, the training data need not be supplied by the RAN controller, which may reduce the load of the RAN controller.

The first communication interface may be further configured to connect the RAN controller to the training application, with the RAN controller being configured to obtain the trained machine-learning model via the first communication interface. This way, the training application does not need to be connected to the second communication interface but can re-use the first communication interface being used for obtaining the training data.

As outlined above, the wireless communication network may be a wireless communication network according to the O-RAN specification. For example, the first communication interface may be a O1 interface according to the O-RAN specification and the second communication interface may be a O2 interface according to the O-RAN specification. By using these existing interfaces, the overhead of an additional interface can be avoided.

Some aspects of the present disclosure relate to a brokering entity for a wireless communication network. The brokering entity comprises interface circuitry and processing circuitry. The brokering entity is configured to obtain, from a RAN controller of the wireless communication network, a request for training a machine-learning model. The brokering entity is configured to trigger an assignment of computational resources of a shared hardware accelerator device being separate from the RAN controller for a training application to be used for training the machine-learning model. The brokering entity thus coordinates the offloading of the training of the machine-learning model, taking into account the hardware resource being available at the shared hardware accelerator device.

For example, the brokering entity may be configured to select or trigger creation of a Logical Processing Unit (LPU) based on the request for training the machine-learning model and based on available computational resources of the shared hardware accelerator device, with the machine-learning model being trained using the LPU. The LPU may be selected or created such, that it is suitable for training the machine-learning model while avoiding starving the use of the shared hardware accelerator device for real-time processing.

According to an example, the shared hardware accelerator device may be accessible via an Acceleration Abstraction Layer (AAL). For example, the brokering entity may be configured to select or create a pre-defined AAL profile according to a machine-learning model-independent template and based on the request for training the machine-learning model. By using a pre-defined AAL profile, an implementation complexity may be reduced. In an embodiment of the present disclosure, the brokering entity may be configured to create a custom AAL profile for the machine-learning model to be trained based on the request for training the machine-learning model. This way, the AAL profile may be improved or optimized for the specific machine-learning model, which may improve the performance of the training, while being more complex to implement.

In various examples, creating the respective AAL profile may comprise at least one of translating the machine-learning model into a format suitable for the AAL profile, selecting a driver for using the assigned computational resources, and selecting a library for using the assigned computational resources. These types of tasks may be used for preparing the training of the machine-learning model on an arbitrary shared hardware accelerator device.

For example, the brokering entity may be configured to create the AAL profile such, that the training application is configured to obtain data to be used for training the machine-learning model from at least one other entity of the wireless communication network. In other words, the training data may be obtained directly (or indirectly) from the source of the data (being separate from the RAN controller), instead of being provided by the RAN controller. This may reduce the load of the RAN controller, as it does not have to act as intermediary for providing the training data.

In various examples, the brokering entity may be configured to trigger an assignment of computational resources of the shared hardware accelerator device for a pre-processing application to be executed using computational resources of the shared hardware accelerator. The training application may be configured to obtain data to be used for training the machine-learning model from the pre-processing application. This way, the data can be prepared in situ, without going through the RAN controller, which may also reduce the load of the RAN controller, as it does not have to act as intermediary for providing the training data.

Some aspects of the present disclosure relate to a corresponding method for a brokering entity for a wireless communication network. The method comprises obtaining, from a RAN controller of the wireless communication network, a request for training a machine-learning model. The method comprises triggering an assignment of computational resources of a shared hardware accelerator device being separate from the RAN controller for a training application to be used for training the machine-learning model.

An aspect of the present disclosure relates to a computer program comprising instructions which, when the program may be executed by a computer, cause the above computer to perform the method for the brokering entity.

Various examples of the present disclosure relate to methods and procedures to enable ML-model training, e.g., in the O-RAN O-cloud. For example, examples of the present disclosure may relate to methods and novel interfaces to enable AI/ML (Artificial Intelligence/Machine Learning)-model training in the O-RAN O-cloud, exploiting hardware accelerator devices deployed in the O-Cloud to train xApp (Near-RT RAN Intelligent Controller, RIC, application)/rApp (Non-RT RIC application)-level models in a transparent and non-conflicting way.

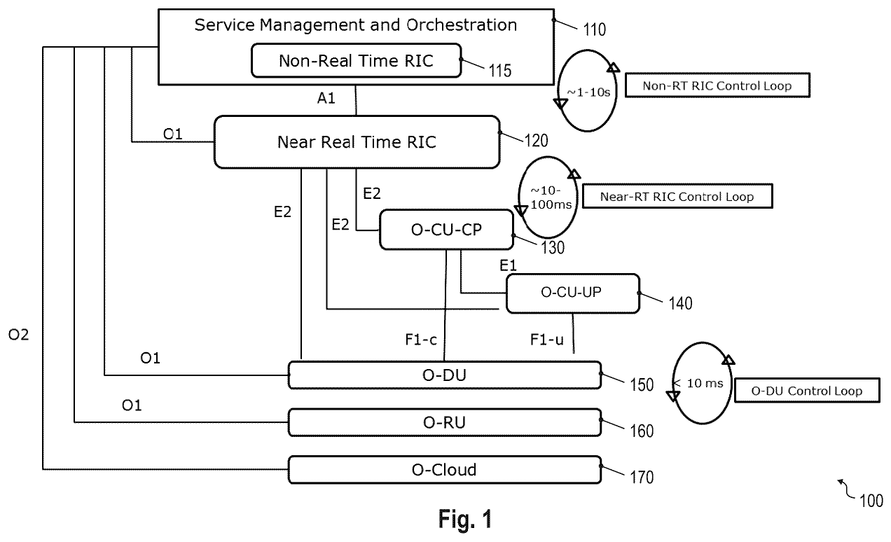

The O-RAN architecture is a collection of open standards aiming create an open and interoperable RAN environment. This allows for multiple vendors to develop, deploy, and manage the RAN components. FIG. 1 shows a schematic diagram of an architecture of infrastructure elements of a wireless communication network according to the O-RAN specification.

FIG. 1 depicts the O-RAN architecture. Key components of the O-RAN architecture include RIC (RAN Intelligent Controller) 115; 120, O-DU (O-RAN Distributed Unit) 150, O-RU (O-RAN Radio Unit) 160, O-FH (O-RAN Fronthaul), O-CU (O-RAN Central Unit) 130; 140, and O-Cloud (O-RAN Cloud) 170. In FIG. 1, two RAN intelligent controllers are shown-a Non-Real Time RIC 115 that is part of Service Management and Orchestration (SMO) 110, and a Near Real Time RIC 120. Moreover, the O-CU is separated into O-CU-CP (O-CU Control Plane) 130 and O-CU-UP (O-CU User Plane) 140. Various interfaces (O1, O2, A1, E2, E1, F1-c and F1-u) are used to connect the different elements.

O-Cloud is a set of hardware and software accelerators that provide cloud computing capabilities for executing various RAN functions on heterogeneous hardware accelerators. RICs are responsible for managing and orchestrating RAN functions. The O-DU processes baseband signals and manages radio resources, while the O-RU transmits and receives radio signals over the air. The O-FH interface connects the O-DU and O-RU, enabling interoperability between different vendors' equipment. The O-CU handles higher-level processing tasks, such as network management and control plane functions.

The RIC architecture foresees two different RIC components, namely the Near-RT RIC 120, which focuses on near-real-time functions, such as dynamic configuration and resource allocation, and the Non-RT RIC 115 that handles non-real-time functions like network planning and resource optimization. The separation of Near-RT RIC and Non-RT RIC enables efficient and scalable management of the RAN, with Near-RT RIC focusing on real-time optimizations and Non-RT RIC handling longer-term planning and optimizations. Software components namely xApps and rApps can be deployed on top of the Near-RT RICs and the Non-RT RICs, respectively. These applications are responsible for providing specific RAN functionalities (e.g., network, mobility, radio, and interference management, security, optimization, analytics, etc.) and may be developed by third-party vendors or by network operators themselves.

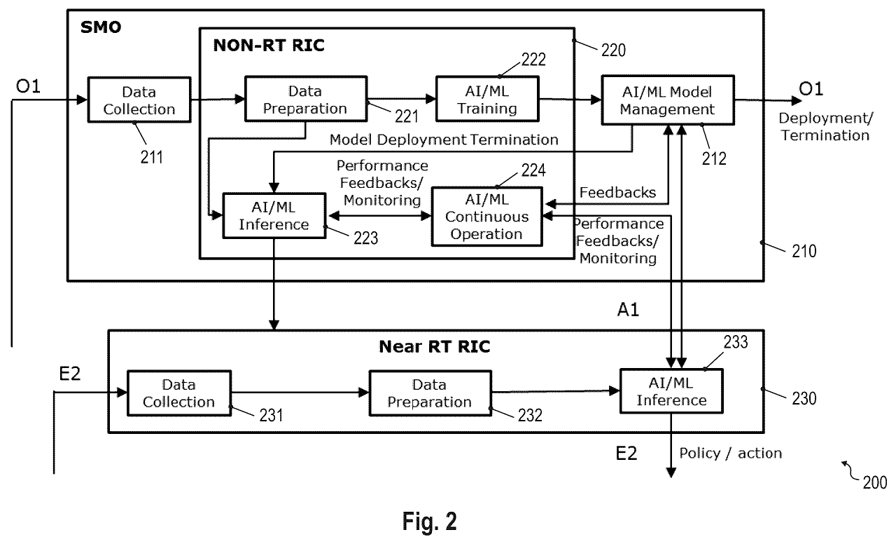

In the following, the training of AI/ML Models in O-RAN, as done in other implementations, is discussed. The present O-RAN design foresees AI/ML-enabled xApps/rApps. The present implementation of AI/ML enablers in O-RAN involves the Near-RT RIC and Non-RT RIC entities, as depicted in FIG. 2. FIG. 2 shows a schematic diagram of an implementation of an AI/ML enabler in a O-RAN Non-RT RIC (as specified in O-RAN. WG2.AIML). In the example shown in FIG. 2, the SMO 210 includes a data collection block 211, which provides data for the Non-Real Time RIC 220. The Non-Real Time RIC includes a data preparation block 221, an AI/ML training block 222, an AI/ML inference block 223 and an AI/ML continuous operation block 224. The data provided by the data preparation block 221 is used both for AI/ML training 222 and for AI/ML inference 223. The trained model is provided to an AI/ML model management block 212, which deploys the trained model for AI/ML inference 223 (and terminates deployment). The AI/ML continuous operation 224 provides performance feedback/monitoring for the AI/ML inference block 223, for an AI/ML inference block 233 of a Near Real Time RIC 230, and for the AI/ML model management block 212. Similarly, the Near Real Time RIC 230 includes another data collection block 231, another data preparation block 232 and the aforementioned AI/ML inference block 233, which uses the data provided by the data preparation block 232 and issues a policy for the O-CU or O-DU.

Data collection boxes 211; 231 collect raw data. The data preparation boxes 221; 232 perform data ingestion, selection, fusion, and cleaning. The AI/ML training box 222, also known as the ML training host, performs functions such as model selection, training and testing, model optimization, and refinement. The AI/ML Inference boxes 223; 233, also known as ML inference hosts, run the model to perform inference. The AI/ML Inference boxes 223; 233, also support online learning functionalities for reinforcement learning models. The continuous operation module controls performance monitoring and analysis, model verification, etc. The present architecture lacks components enabling the training task offloading in the O-Cloud (see O-RAN. WG2.AIML-v01.03). Indeed, regarding rApps, the O2 interface is designed to support only the management and provisioning of network functions, while it does not support the exchange of data like model weights, which is critical for the offloading of the training task. Similarly, for xApps, the Ol interface (the interface between Service Management and Orchestration, SMO, and O-RAN managed elements) is intended to manage RAN components and network functionalities, but again does not support data exchange. Moreover, it does not have a direct connection to the O-Cloud, which is necessary for supporting the offloading of training of AI/ML-models running in xApps.

The Acceleration Abstraction Layer (AAL) is a software layer that provides a standardized interface between the O-RAN data plane and hardware acceleration resources. It is responsible for abstracting the underlying hardware details of the acceleration resources, allowing them to be accessed through a standardized interface. In the O-RAN context, the AAL runs low-level 5G (5 th Generation wireless/cellular communication network according to the Third Generation Partnership Project, 3GPP) protocol stack functions occurring at PHY (Physical)/MAC (Media Access Control) level, in particular those functionalities related to signal processing, coding/decoding, modulation/demodulation, etc. and, in general, functionalities which require a specialized hardware to accelerate the execution of the specific function and offload/reduce the CPU workload.

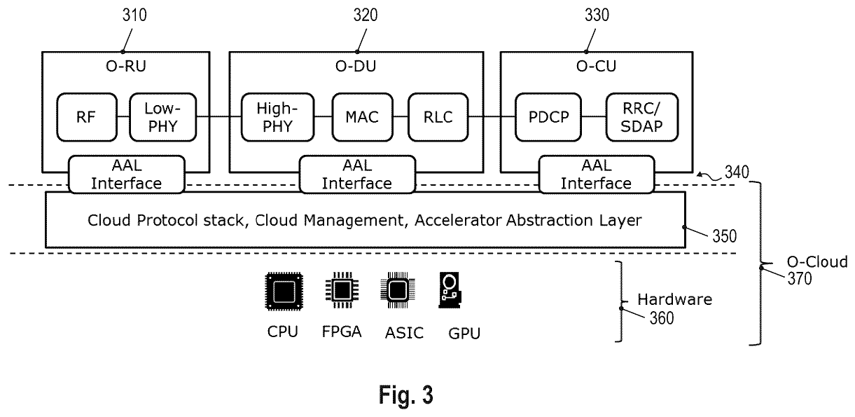

FIG. 3 shows a high-level overview of the Acceleration Abstraction Layer (AAL). O-RU 310 (e.g., a RF (Radio Frequency) component and a low-level PHY component thereof), O-DU 320 (e.g., a High-level PHY component, a MAC component and an RLC, Radio Link Control, component thereof), and O-CU 330 (e.g., a PDCP, Packet Data Convergence Protocol, and an RRC/SDAP, Radio Resource Control/Service Data Adaptation Protocol, component thereof) use AAL interfaces 340, which are based on a cloud protocol stack, cloud management and the AAL 350 to provide access to computational resources provided by the hardware 360, e.g., one or more Central Processing Units (CPUs), one or more FPGAs (Field-Programmable Gate Arrays), one or more ASICs (Application-Specific Integrated Circuits) and/or one or more GPUs (Graphics Processing Units). The cloud protocol stack, cloud management and the AAL 350 and the hardware 360 form the O-Cloud 370.

As depicted in FIG. 3, the range of implementation options includes general-purpose processors such as CPUs, more specialized processors such as GPUs, functions implemented on field-programmable gate arrays (FPGAs), and fixed-functions implemented on application-specific integrated circuits (ASICs).

The AAL provides a common language for different O-RAN functional elements to interact with hardware acceleration resources, regardless of the specific hardware platforms they are running on. This allows different vendors to develop their own implementations of hardware acceleration resources, while ensuring interoperability between different implementations.

The Acceleration Abstraction Layer provides the main following features. It provides standardized Interfaces: The AAL provides standardized interfaces for O-RAN functional elements to interact with hardware acceleration resources. This includes interfaces for acceleration resources such as FPGAs (Field-Programmable Gate Arrays), GPUs (Graphics Processing Units), and ASICs (Application-Specific Integrated Circuits). It further provides hardware abstraction: The AAL abstracts the underlying hardware details of the acceleration resources. This includes the physical interfaces, programming models, and hardware capabilities of the acceleration resources. It further provides software abstraction: The AAL abstracts the underlying software details of the acceleration resources. This includes the drivers, APIs (Application Programming Interfaces), and SDKs (Software Development Kits) of the acceleration resources. It further provides interoperability: The AAL ensures interoperability between different implementations of acceleration resources. This allows mobile network operators to choose the best solution for their specific needs, without being locked into a single vendor's solution.

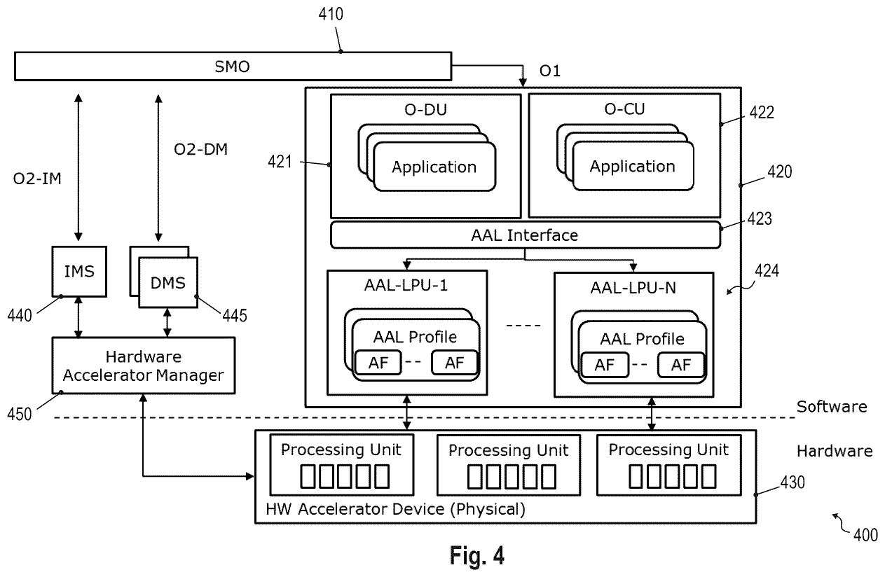

FIG. 4 shows a high-level overview of an architecture, in which the AAL is used (i.e., a high-level AAL architecture diagram). FIG. 4 shows the SMO 410, which uses the Ol interface to communicate with a software portion 420 of the O-Cloud, which is used to run applications for O-DU 421, O-CU 422, and which includes an AAL interface 423 to access AAL-LPUs (AAL Logical Processing Units) 424, which execute so-called AAL profiles for the O-DU and O-CU. FIG. 4 further shows an IMS (Infrastructure Management Service) 440 and one or more DMS (Deployment Management Services) 445, which are coupled to a hardware accelerator manager 450, which is used to control a (physical) hardware accelerator device 430, which forms a hardware portion of the O-Cloud.

FIG. 4 describes the AAL architecture diagram. A hardware accelerator 430 may support 1 to N AAL-LPUs 424. The AAL Logical Processing Unit (LPU) is a logical representation of resources within an instance of an HW Accelerator. For example, there can be multiple processing units on a hardware accelerator, or resource partitioning (dedicated resources, shared resources) and these can be logically represented as a AAL Logical Processing Unit). An AAL-LPU may support more than one AAL profile. For each supported AAL profile, an AAL-LPU may execute 0 to N AAL-Profile-Instances. An AAL Queue is exposed by the AAL Profile Instance's API and may be used by the AAL Application to group operations together. For example, AAL Queues may access specific resources (computing, Input/Output) of an AAL-LPU executing specific AAL Profile Instances(s).

The hardware (HW) accelerator manager 450 is an acceleration management function, that provides management capabilities for the HW Accelerator(s) in the O-Cloud Node. Management capabilities include (but are not limited to) lifecycle management, configuration, updates/upgrades, and failure handling. The HW Accelerator Manager is running as software instance in the O-Cloud Platform.

The O1 Interface between management entities in Service Management and Orchestration Framework and O-RAN managed elements is used for operation and management like FCAPS management (fault, configuration, accounting, performance, security), Software management, File management. According to the present specification, it does not support sharing of ML models nor monitoring data.

The O2 interface is how the SMO 410 communicates with the O-Cloud. Network operators that are connected to the O-Cloud can then operate and maintain the network with the O1 or O2 interfaces by reconfiguring network elements, updating the system, or upgrading the system. The O2 includes a set of different interfaces, which are provided by the O-Cloud platform to the SMO. The services are categorized into two logical groups: (i) Infrastructure Management Services (IMS) 440, which include the subset of O2 functions that are responsible for deploying and managing cloud infrastructure. (ii) Deployment Management Services (DMS) 445, which include the subset of O2 functions that are responsible for managing the lifecycle of virtualized/containerized deployments on the cloud infrastructure.

As the field of artificial intelligence and machine learning continues to grow and evolve, one of the biggest challenges faced by researchers and practitioners alike is the availability of data for training models. It's crucial to have a large set of data to train on, but obtaining this data can be difficult and time-consuming. In the O-RAN context, xApps/rApps rely on the O1 Interface to retrieve real-time monitoring information from the lower layers of the architecture, including performance data, network performance data, alarm and fault data, inventory data, etc. Various examples of the present disclosure are based on the assumption, that AI/ML models within xApps/rApps will often rely on KPIs (Key Performance Indicators) and metrics made available from the Ol interface and generated by DU level. Such data currently needs to be moved to the near-RT RIC/non-RT RIC for training (or continuous training) of ML-based models, increasing communication overhead. Moving training data brings non-negligible costs, therefore, AI/ML models may be trained where data is available.

According to the present O-RAN standard definitions, the AAL layer is not accessible to xApps/rApps or to the Near-RT/Non-RT RIC. Moreover, HW accelerators deployed within the O-Cloud premises are reserved for DU/CU task processing, e.g., accelerate PHY/MAC layer functionalities. As the adoption of HW accelerators goes from ad-hoc ASIC/FPGA implementations that can hardly be shared, towards general purpose GPU hardware which can easily run parallel tasks belonging to different pipelines, according to the proposed concept, such processing power can be opportunistically used to offload ML-training tasks occurring at higher RICs Level in the O-Cloud space, reducing the computational burden occurring at the RICs premise.

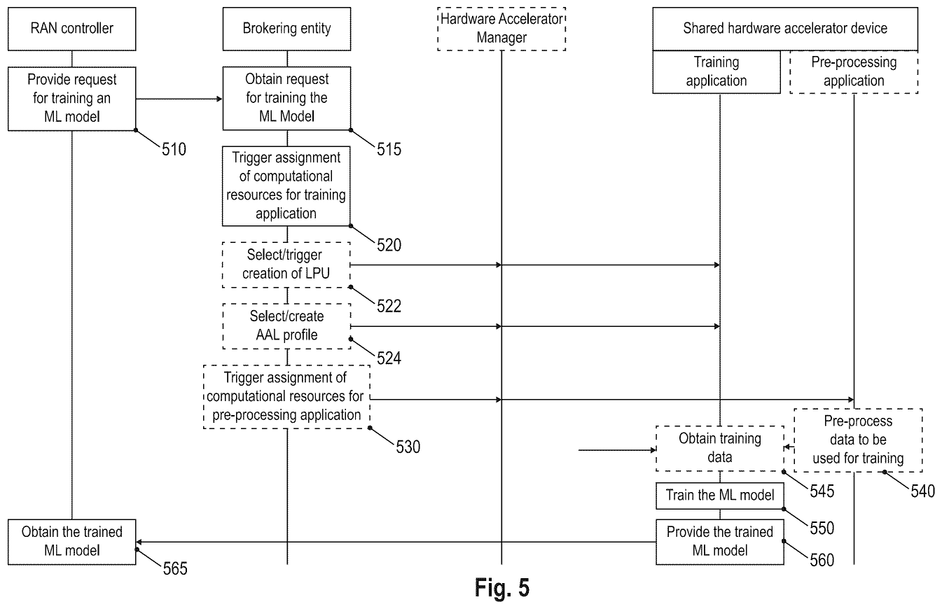

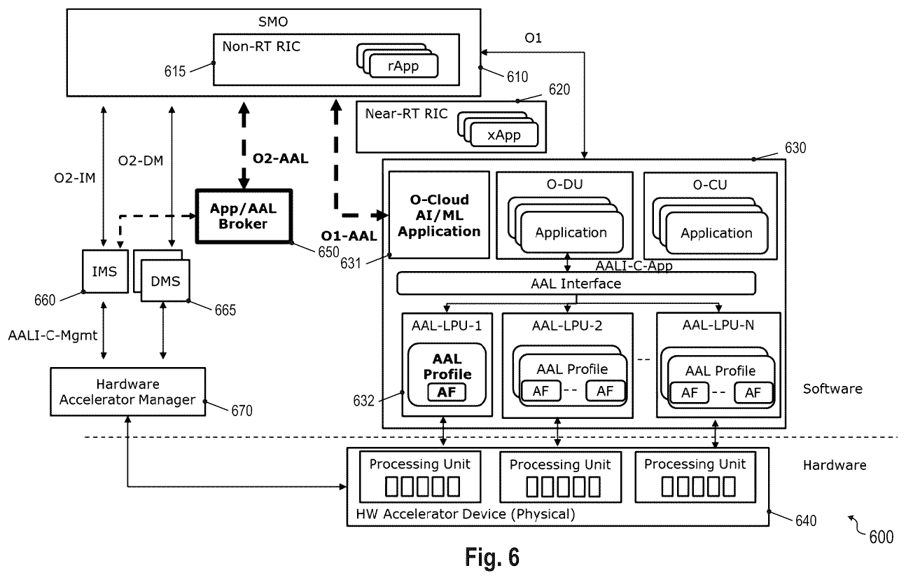

FIG. 5 shows a flow chart of an example of a method for training a machine-learning model for use in a RAN controller, such as the aforementioned Non-Real Time RAN Intelligent Controller and Near Real Time RAN Intelligent Controller. Such controllers are shown in FIGS. 6, 7b, 8b and 10, for example.

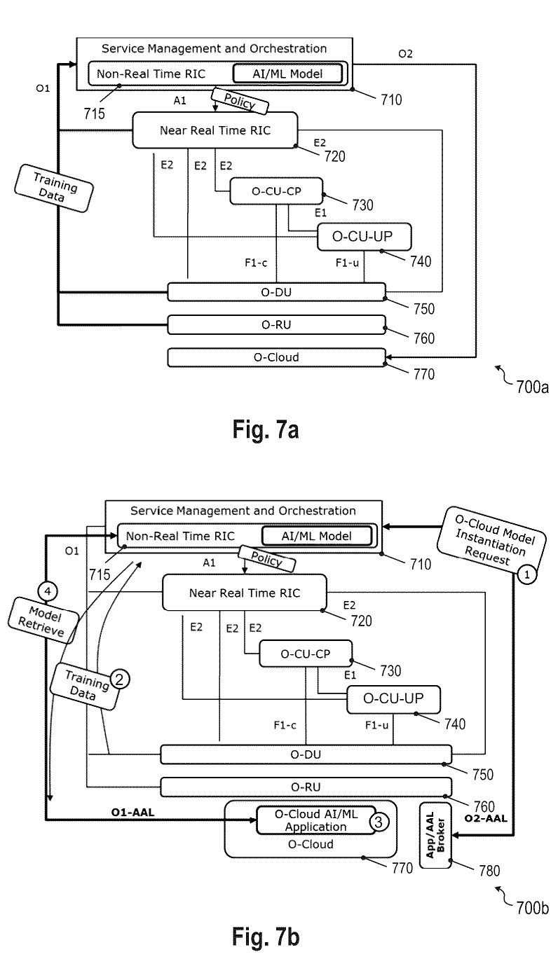

The method comprises providing 510, by the RAN controller (e.g., Non-RT RIC 615; 715; 815; 1015 or Near RT RIC 620; 720; 820; 1020 of FIGS. 6, 7b, 8b and 10), a request for training a machine-learning model to a brokering entity (e.g., App/AAL Broker 650; 780; 880; 1080 in FIGS. 6, 7b, 8b and 10). The method comprises triggering 520, by the brokering entity, an assignment of computational resources of a shared hardware accelerator device (e.g., HW Accelerator Device 640 of FIG. 6, O-Cloud 770; 870; 1070 of FIGS. 7b, 8b and 10) being separate from the RAN controller for a training application (O-Cloud AI/ML Application of FIGS. 6, 7b, 8b and 10) to be used for training the machine-learning model. The method comprises training 550, by the training application and using the assigned computational resources, the machine-learning model. The method comprises providing 560 (e.g., by the training application) the trained machine-learning model to the RAN controller (and obtaining 565, by the RAN controller, the trained machine-learning model). For example, the RAN controller may perform inference using the trained machine-learning model.

For example, the method may be performed by a wireless communication network comprising the aforementioned RAN controller, brokering entity, and shared hardware accelerator device, such as the wireless communication networks 600; 700b; 800b; 1000 of FIGS. 6, 7b, 8b and 10. For example, the RAN controller may be configured to provide the request for training a machine-learning model to the brokering entity, the brokering entity may be configured to trigger the assignment of computational resources of the shared hardware accelerator device for the training application to be used for training the machine-learning model, the shared hardware accelerator device may be configured to execute the training application, and the RAN controller may be configured to obtain the trained machine-learning model from the training application.

In some examples, the method may be performed by the components of a wireless communication network according to the Open RAN specification. For example, the RAN controller may be a O-RAN Near-Real-Time RAN Intelligent Controller or a O-RAN Non-Real-Time RAN Intelligent Controller. The shared hardware accelerator device may be associated with a O-RAN Cloud (O-Cloud) of the wireless communication network, e.g., the hardware accelerator device 640 shown in FIG. 6. In general, the shared hardware accelerator device may be a shared hardware accelerator device used for accelerating at least one function of at least one of a central unit (e.g., O-CU) of the wireless communication network and one or more distributed units (e.g., O-DU) of the wireless communication network. The shared hardware accelerator device may thus be a hardware device comprising accelerator hardware (such as one or more GPUs, one or more ASICs, one or more FPGAs and/or one or more server-grade CPUs) that is used to provide computational resources for other components (such as the central unit and/or the distributed units) of the wireless communication network. For example, the shared hardware accelerator device may form or correspond to a hardware component of the O-RAN Cloud of the wireless communication network according to the O-RAN specification.

Portions of the method may be performed by the respective entities, e.g., by the RAN controller, the brokering entity, the training application etc. Some examples of the present disclosure relate to a method for the brokering entity, with the method comprises obtaining 515, from the Radio Access Network, RAN, controller of the wireless communication network, the request for training a machine-learning model, and triggering 520 the assignment of computational resources of the shared hardware accelerator device being separate from the RAN controller for the training application to be used for training the machine-learning model. Some other examples may relate to other aspects of the method of FIG. 5, e.g., with respect to the RAN controller, with respect to the shared hardware accelerator device etc. Moreover, some examples of the present disclosure relate to the brokering entity being configured to perform the aspects of the method of FIG. 5 that are being performed by the brokering entity. For example, the brokering entity may comprise interface circuitry (i.e., circuitry for communicating with one or more further components of the wireless communication network), processor circuitry (e.g., one or more processors, for providing the functionality of the brokering entity, e.g., for performing the aspects of the method being performed by the brokering entity) and memory circuitry (for storing information, such as machine-readable instructions which, when executed by the processor circuitry, implement the aspects of the method being performed by the brokering entity). Some other aspects of the present disclosure relate to a computer program comprising instructions which, when the program is executed by a computer, cause the computer to perform the aspects of the method being performed by the brokering entity.

In the following, various aspects of the method of FIG. 5 will be introduced in more detail with reference to the concrete implementations shown in connection with FIGS. 6 to 10.

FIG. 6 shows an example of an extended architecture, in which the AAL is used. To support the proposed concept, the architecture may be extended in several ways. Similar to the example shown in FIG. 4, FIG. 6 shows the SMO 610 (comprising the Non-RT RIC 615 being configured to execute rApps), which uses the Ol interface to communicate with a software portion 630 of the O-Cloud, which is used to run applications for O-DU, O-CU, and the O-Cloud AI/ML Application 631 (i.e., the training application), and which includes an AAL interface to access AAL-LPUs (AAL Logical Processing Units), which execute so-called AAL profiles for the O-DU and O-CU, including an AAL-LPU 632 to execute an AAL profile for the O-Cloud AI/ML Application 631. FIG. 6 further shows the Near-RT RIC 620, configured to execute xApps. FIG. 6 further shows an IMS (Infrastructure Management Service) 660 and one or more DMS (Deployment Management Services) 665, which are coupled to a hardware accelerator manager 670, which is used to control a (physical) hardware accelerator device 640, which forms a hardware portion of the O-Cloud. FIG. 6 additionally shows the App/AAL Broker 650 (i.e., the brokering entity), which communicates with the SMO via a new O2-AAL interface, and which communicates with the hardware accelerator manager 670 via the IMS 660.

The HW Accelerator Manager 670 manages the configuration of the HW Accelerator 640 (i.e., the shared hardware accelerator device) as prescribed by the SMO through the AALI-C-Mgmt interface. The configuration of the HW Accelerator Manager may include HW Accelerator resource assignment to AAL-LPUs. At the same time, the HW Accelerator Manager oversees the creation and onboard of new AAL-LPUs and AAL profiles. For example, as further shown in FIG. 5, the brokering entity may be configured to trigger the assignment of the computational resources via the hardware accelerator manager. For example, the brokering entity may request the hardware accelerator manager 670 (e.g., via the IMS 660) to select or create an LPU, and it may upload or select an AAL profile implementing the training application (and a pre-processing application, if applicable).

To facilitate AI/ML model training at the O-Cloud level, the functionalities of the O2-interface may be extended, dubbed as 02-AAL by connecting the Non-RT RIC 615 and HW Accelerator Manager 670. This enables the discovery, setup, and loading of AAL Profiles and AAL-LPUs within the O-Cloud platform. This feature may be implemented proactively by using templates, or reactively by dynamically creating AAL Profiles and AAL-LPUs based on the specific characteristics of the AI/ML Model being trained. The data may include high-level RIC-related monitoring metrics, KPIs, or other relevant information such as existing control policies.

As shown in FIG. 6, running the training application on the shared hardware accelerator device may be implemented using two existing mechanisms of the O-RAN architecture-a Logical Processing Unit (LPU), and an AAL profile. Therefore, triggering assignment of the computational resources may comprise selecting or triggering creation 522 of a LPU based on the request for training the machine-learning model and based on available computational resources of the shared hardware accelerator device. The machine-learning model may then be trained using the LPU (e.g., as shown in FIG. 6, where AAL-LPU-1 is used to train the machine-learning model). In general, two approaches may be used-either a pre-defined or default LPU may be selected or created (according to a template), or an LPU with a custom configuration that is tailored to the machine-learning model being trained may be created. In other words, the method may comprise selecting (of an existing LPU) or triggering creation of, by the brokering entity, a pre-defined LPU according to a machine-learning model-independent template. Alternatively, the method may comprise triggering, by the brokering entity, creation of a custom LPU for the machine-learning model to be trained (i.e., that is created specifically for, and based on, the machine-learning model being trained). Similarly, an AAL profile may be selected or created. For example, as discussed in connection with FIGS. 3 and 4, the shared hardware accelerator device may be accessible via an Acceleration Abstraction Layer (AAL, e.g., according to the O-RAN specification). The training of the machine-learning model may be based on an AAL profile, with the AAL profile specifying the training application with one or more accelerated functions to be processed by the shared hardware accelerator device on behalf of the RAN controller, and the one or more accelerated functions comprising the training of the machine-learning model. In other words, the AAL profile may be regarded as a bundle or container that is used to specify one or more applications (i.e., accelerated functions) that are to be executed by the LPU. One of the one or more applications being specified by the AAL profile is the training application being used to train the machine-leaning model. Again, a default or pre-defined AAL profile may be used (e.g., the machine-leaning model and/or hyperparameters for training the machine-learning model may be inserted into a generic AAL profile that is suitable for training arbitrary machine-learning models. In this case, the method of FIG. 5 may comprise selecting or creating, by the brokering entity, a pre-defined AAL profile according to a machine-learning model-independent template and based on the request for training the machine-learning model. In an embodiment of the present disclosure, a custom AAL profile may be created based on the machine-learning model being trained. In other words, the method may comprise creating, by the brokering entity, a custom AAL profile for the machine-learning model to be trained based on the request for training the machine-learning model. In this case, the parameters and software libraries specified by the AAL profile may be tailored to the machine-learning model. In both cases, creating the respective AAL profile may comprise at least one of translating the machine-learning model into a format suitable for the AAL profile, selecting a driver for using the assigned computational resources, and selecting a software library for using the assigned computational resources.

One key advantage of the proposed concept is that it allows for possible training data related to CU/DU functionalities to be directly fed into the model, without the need to bring such metrics to higher architectural levels as is typical in traditional training schemes involving Non-RT RIC level training and/or Training Host platforms. In other words, the method may comprise obtaining 545, by the training application and based on the request, data to be used for training the machine-learning model from at least one other entity of the wireless communication network. Accordingly, the brokering entity may be configured to create the AAL profile such, that the training application (and/or a pre-processing application) is configured to obtain data to be used for training the machine-learning model from at least one other entity of the wireless communication network. This reduces overall system communication overhead and improves the overall system efficiency, as later presented in embodiment 3. For example, the data may be obtained one at least one of a central unit (e.g., O-CU), at least one distributed unit (e.g., O-DU), and/or at least one radio unit (e.g., O-RU). In particular, the data to be used for training the machine-learning model may be obtained from at least one distributed unit of the wireless communication network.

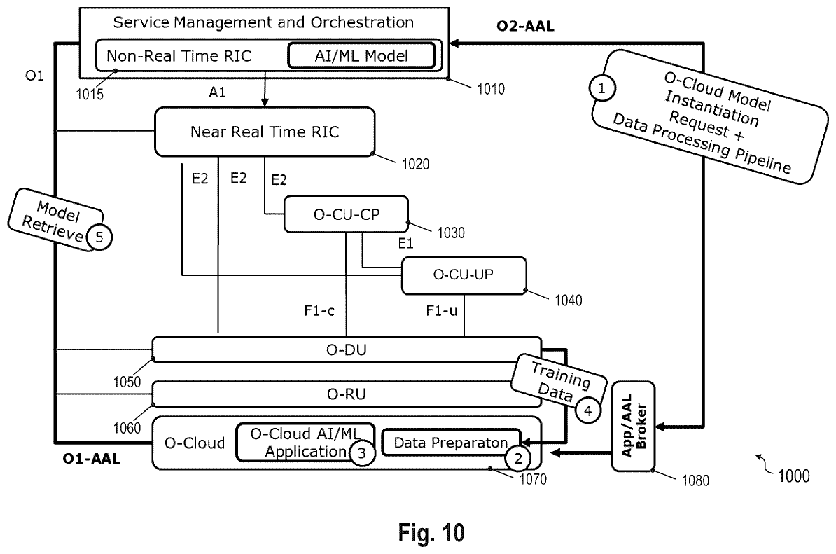

In some examples, as will be shown in more detail in connection with FIG. 10, the data being used for the training may be pre-processed using computational resources of the shared hardware accelerator device. In other words, the method (of FIG. 5) may comprise pre-processing 540, by a pre-processing application (shown as “data preparation” block within the O-Cloud 1070 in FIG. 10) being executed using computational resources of the shared hardware accelerator, the data to be used for training the machine-learning model. The pre-processed data may then be used for training the machine-learning model. In addition to triggering assignment of computational resources for the training application, the brokering entity may further trigger assignment of computational resources for the pre-processing application (see FIG. 5, block 530). Accordingly, the brokering entity may be configured to trigger an assignment of computational resources of the shared hardware accelerator device for the pre-processing application to be executed using computational resources of the shared hardware accelerator, with the training application may be configured to obtain data to be used for training the machine-learning model from the pre-processing application. The brokering entity may use the same approach for triggering assignment of the computational resources for the pre-processing application that were previously described with respect to triggering assignment of the computational resources for the training application. This may include selecting or triggering creation of an LPU (in case the LPU being used for the training application is not also used for the pre-processing application) and selecting or creating an AAL profile.

To obtain the data for the training (or for the pre-processing data), the data may be obtained via the existing interfaces of the wireless communication network. For example, the wireless communication network may comprise a first communication interface configured to connect the RAN controller to at least one of a central unit, a distributed unit, and a radio unit of the wireless communication network, and/or to connect at least one of the central unit, the distributed unit, and the radio unit to the training application and/or to the pre-processing application. The data to be used for training (and/or the data being pre-processed) may then be obtained, by the training application and/or the pre-processing application, via the first communication interface. In other words, the training application and/or the pre-processing application may be configured to obtain data for training the machine-learning model via the first communication interface. For example, the first communication interface may correspond to the O1 interface of the wireless communication network according to the O-RAN specification. In some examples, as will be shown in connection with FIGS. 7b, 8b and 10, the first communication interface may be further used to provide the trained machine-learning model from the training application to the RAN controller. In other words, the first communication interface may be further configured to connect the RAN controller to the training application, with the RAN controller being configured to obtain the trained machine-learning model via the first communication interface.

The wireless communication network may further comprise a second communication interface (e.g., the O2 interface of the wireless communication device according to the O-RAN specification) configured to connect the RAN controller to the brokering entity. This second interface is shown as O2 interface in FIGS. 6 to 10, with a O2-AAL connection being used to connect the RAN controller 615 to the brokering entity 650.

In the following, three exemplary embodiments are shown, which relate to the training of rApp models (embodiment 1), the training of xApp models (embodiment 2), and the use of a processing pipeline as AAL-Profile instance in the O-Cloud (embodiment 3). It is noted that features described in connection with one of the embodiments may also be included in the other embodiments. Except for the requester and recipient of the trained model (which are different between embodiment 1 and 2, the same techniques may be used across embodiments.

The first embodiment relates to the training of rApp models for use in the Non-RT RIC.

FIGS. 7a and 7b both show the SMO 710 with the Non-RT RIC 715 which executes an AI/ML-based rApp, the Near-RT RIC 720, O-CU-CP 730, O-CU-UP 740, O-DU 750, O-RU 760 and O-Cloud 770. FIG. 7a shows an example of a workflow for rApp ML model training in the Non-RT RIC, as applied according to the present O-RAN specification. In the example of FIG. 7a, the training data is provided, by O-RU and O-DU, to the Non-RT RIC 715, with the AI/ML model (i.e., the machine-learning model) being trained in the Non-RT RIC 715 (e.g., as shown in FIG. 2). FIG. 7b shows an example of a workflow for rApp ML model training in the O-Cloud. In FIG. 7b, the Non-RT RIC 715 provides an O-Cloud model instantiation request (e.g., the request for training the machine-learning model) to the App/AAL Broker 780 (e.g., the brokering entity). The O-Cloud AI/ML Application (i.e., the training application) is instantiated in the O-Cloud 770. The data to be used for training is obtained, either indirectly via the Non-RT RIC or directly via the O1 interface, from the O-DU and/or the O-RU. After training, the trained model is retrieved by the Non-RT RIC via the O1-AAL interface.

In FIGS. 7a and 7, example workflows are depicted with respect to the scenario of an rApp model to be trained in the Non-RT RIC (FIG. 7a), compared to the proposed approach of training the machine-learning model at O-cloud level (FIG. 7b). The presence of a preliminary discovery phase is assumed in which the Non-RT RIC can, by exploiting the O2 interface (namely O2-IM, O2-DM), obtain information regarding the O-Cloud platform availability, and start the definition and instantiation of an AAL Profile based on the characteristics of the specific AI/ML model to be trained, through the novel App/AAL broker entity 780.

In this preliminary setup phase, an LPU logical representation of the resources within the available HW accelerator may be set and made available to the AAL layer prior to the effective deployment of AI/ML Models. The actual LPU representation will depend on specific HW accelerator devices installed at the E2 nodes (i.e. the underlying O-RAN nodes that comprise the RAN functions (O-CU, O-DU and O-RU) and that are connected to the Near-RT RIC via the E2 interface). With reference to FIG. 7, at (1), the Non-RT RIC performs a deployment_request to the App/AAL Broker exploiting the O2-AAL interface. The request includes the AI/ML model to be trained, and a set of auxiliary metadata information including one or more of items of the non-exhaustive set of information: Model type, input data list, data pre-processing details, e.g., aggregation functions, etc., AI/ML model hyperparameters etc.

Upon receiving an AI/ML Model training request message, the AAL layer can optionally, and in presence of soft partitions of HW accelerators (e.g., in presence of sharable devices like GPUs), schedule access of heterogeneous tasks in a prioritized manner, e.g., ensuring that DU-related tasks will be executed with higher priority with respect to xApp/rApp AI/ML models guaranteeing the operational requirements of PHY/MAC layer processes, especially in terms of processing latency. As a result, the at least one function of the central unit and/or the one or more distributed units are prioritized over the training of the machine-learning model during assignment of the computational resources. This operation ends with the setup of a dedicated AAL-LPU for the specific AI/ML application.

At (2), training data and metrics used to train the AI/ML Application are collected and retrieved from the Ol interface following standardized procedures. In the example shown in FIG. 7b, the data may be sent back to the O-Cloud AI/ML Application following the extended capabilities of the O1-AAL interface.

At (3), the AI/ML application is trained by using as input the data provided by the O1-AAL interface. The training process occurs within the predefined LPU instance. In this way the training can seamlessly exploit the available set of HW accelerators functionalities, offloading computational burden from the Non-RT RIC.

At (4), upon completion of the training task, the trained model can be retrieved and instantiated at Non-RT RIC for inference tasks, or parts of if (for example its weights, etc.) can be used to update an already existing model instances running in the Non-RT RIC. This step can also be performed by exploiting the proposed extended scope of the O1-AAL interface.

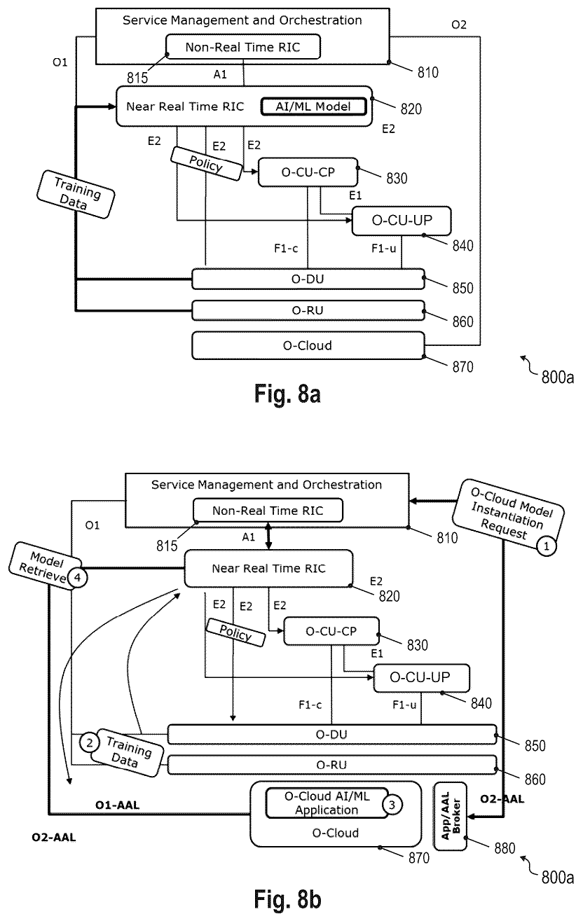

In the second embodiment, the training of xApp models for use in the Near-RT RIC is discussed. FIGS. 8a and 8b both show the SMO 810 with the Non-RT RIC 815, the Near-RT RIC 820 (which executes an AI/ML-based xApp), O-CU-CP 830, O-CU-UP 840, O-DU 850, O-RU 860 and O-Cloud 870. FIG. 8a shows an example of a workflow for xApp ML model training in the Near-RT RIC, as applied according to the present O-RAN specification. In the example of FIG. 8a, the training data is provided, by O-RU and O-DU, to the Near-RT RIC 820, with the AI/ML model (i.e., the machine-learning model) being trained in the Near-RT RIC 820 (e.g., as shown in FIG. 2). FIG. 8b shows an example of a workflow for xApp ML model training in the O-Cloud. In FIG. 8b, the Near-RT RIC 820 provides an O-Cloud model instantiation request (e.g., the request for training the machine-learning model), via the Non-RT RIC 815, to the App/AAL Broker 880 (e.g., the brokering entity). The O-Cloud AI/ML Application (i.e., the training application) is instantiated in the O-Cloud 870. The data to be used for training is obtained, either indirectly via the Near-RT RIC or directly via the Ol interface, from the O-DU and/or the O-RU. After training, the trained model is retrieved by the Near-RT RIC via the O1-AAL interface.

In FIGS. 8a and 8b, an example workflow is depicted with respect to the scenario of an xApp model to be trained in the Near RT-RIC (FIG. 8a), compared to the proposed approach to train it at O-cloud level (FIG. 8b). Like the scenario described in the previous embodiment, an initial offline phase may be used to establish, configure, and upload the specific AAL profiles and LPU mapping criteria to the O-Cloud infrastructure. This operation may be performed by exploiting the App/AAL Broker and the O2-AAL interface.

However, in this particular scenario, an O2 interface might not be available at the Near RT-RIC. Therefore, a deployment_request message may be transmitted via the Al interface (the interface between the Non-RT RIC and the Near-RT-RIC) and forwarded through the extended O2-AAL by the Non-RT RIC, as shown in operation (1). In an embodiment of the present disclosure, if an O2 interface endpoint is added to or included in the Near RT-RIC, the request can be sent directly from the Near RT-RIC to the O-Cloud.

As in the previous case, training data may be collected exploiting the already available O1 endpoints and procedures and moved towards the Near-RT RIC. Subsequently, this data may be forwarded to the running O-Cloud AI/ML application (2) to benefit from the hardware accelerators devices available in the O-Cloud and offload computing processes. The model is trained adopting a dedicated LPU in the O-Cloud premises (3). Upon training, the model is collected and moved back to the Near RT-RIC, following the O1-ALL interface with the Non-RT RIC (4).

The third embodiment relates to a processing pipeline as AAL-Profile instance in the O-Cloud.

As previously discussed, the AAL profile definitions according to the present O-RAN specification only consider DU/CU functionalities mainly related to signal processing, such as FEC (Forward Error Correction), CRC (Cyclic Redundancy Check) Generation, LDPC (Low-Density Parity Check) Encoding, PDSCH (Physical Downlink Shared Channel) Rate Matching, IQ sample compression, etc., and do not consider generic processing pipelines. Moreover, the O-cloud functionalities are currently operated in an offline fashion, with the update of AAL-profiles and LPU mapping occurring through slow operation and maintenance activities.

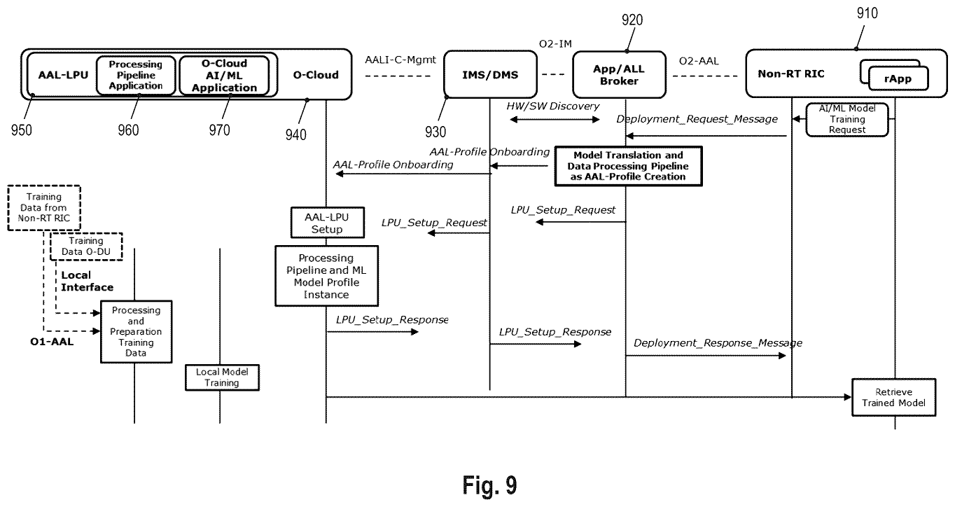

To further improve the processing of statistics and achieve the full solution, the dynamic setup of local processing pipelines within the O-Cloud premises may be provided, as depicted in FIG. 9. FIG. 9 shows a proposed workflow for rApp ML model training in the O-Cloud and local data processing pipeline setup. The workflow implies an initial deployment_request message from the Non-RT RIC 910 (in response to an AI/ML model training request by an rApp) towards the App/ALL Broker 920 through the novel O2-AAL interface, which may include one or more items of the following non-exhaustive set of parameters and information: Input Data and metrics, data pre-processing details, e.g., aggregation functions, etc., model type (may come from catalog), AI/ML model hyperparameters, etc. At this point, it is assumed that the App/AAL Broker 920 has already performed hardware discovery procedure and collected exhaustive information about the available hardware accelerator capabilities, as well as the current LPU mapping and corresponding resource availability (for the purpose of determining the computational resources being available for assignment to the training application). Upon receiving the deployment message, the App/ALL Broker is in charge of generating the AAL-Profile of the incoming AI/ML model application (i.e., the training application) and processing pipeline. This operation involves knowledge on the particular model functionalities so as to be able to optimize the AAL-Profile creation and match the best HW accelerator libraries and drivers. The operation ends with the onboarding of the generated AAL-Profiles into the O-Cloud 940 premises (via IMS/DMS 930) through existing O2-IM and AALI-C-Mgmt interfaces and related procedures.

When in presence of sharable HW accelerator devices such as GPUs, the App/ALL Broker 920 may optionally oversee and dynamically control the LPU setup procedure by LPU_Setup_Request messages, which include detailed information regarding LPU mappings to be instantiated according to, e.g., real-time system load and/or requirements. An accurate allocation of HW accelerator resources may be beneficial to improve or optimize the training procedure of AI/ML application instances, reduce or minimize energy consumption, and avoid interfering with other already running CU/DU processes within the same HW accelerator. Thus, assignment of computational resources is based on their availability, with the CU/DU processes receiving a higher priority during assignment of computational resources.

Raw data metrics necessary to train the AI/ML Application may be readily available from the DU. In this case, a local processing pipeline 960 may be setup as AAL-Profile instance within the O-Cloud infrastructure to e.g., perform preprocessing tasks required to prepare the input data for the AI/ML model, following the information and criteria provided in the deployment_request. In this way, data can be processed where available, without the need to move monitoring information at the upper layers of the architecture enabling significant overhead and bandwidth savings. The setup ends with a deployment_response message indicating whether the deployment successfully occurred, or not, as well as its relevant endpoints for subsequent life-cycle management operations.

The AI/ML application is then trained by using as input the data provided by the local preparation function. The training task is executed within the already established LPU instance 950, which may include both the processing pipeline application 960 and the O-Cloud AI/ML application 970. In this way the training process can seamlessly exploit the available set of HW accelerators functionalities and resources, offloading computational burden from the Non-RT RIC. The trained model can then be retrieved by the O1-AAL interface, as discussed in the previous embodiments.

FIG. 10 depicts the overall simplified workflow and the main architectural components involved. FIG. 10 shows an example of an rApp ML model training and related data processing pipeline in the O-Cloud. Similar to FIGS. 7b and 8b, FIGS. 10a and 10b both show the SMO 1010 with the Non-RT RIC 1015 820 (which executes an AI/ML-based rApp), the Near-RT RIC 1020, O-CU-CP 1030, O-CU-UP 1040, O-DU 1050, O-RU 1060, O-Cloud 1070 and App/AAL broker 1080. In the example of FIG. 10, an O-Cloud model instantiation request (which includes a request for instantiating a data processing pipeline) is provided by the Non-RT RIC 815 to the App/AAL broker 1080. Training data is provided to a data preparation application (i.e., the pre-processing application), which provides pre-processed data for use in the training of the AI/ML model to the O-Cloud AI/ML application. Both applications are executed in the O-Cloud. Finally, the trained machine-learning model is retrieved by the Non-Real Time RIC from the O-Cloud (e.g., the training application).

Various examples of the present disclosure relate to a method for enabling AI/ML model training in the O-RAN O-cloud, exploiting hardware accelerator devices deployed in the O-Cloud. The method may comprise the operations (e.g., steps) of (1) creating and onboarding an AAL profile of the target AI/ML model to be trained in the O-Cloud as defined by the deployment request message received over the novel O2-AAL interface, (2) creating an LPU mapping, depending on the HW accelerator devices available in the O-Cloud premises, (3) deploying the AI-ML model as an AI-ML Application in the O-Cloud premises, (4) training the model and (5) retrieving an updated version through the novel O1-AAL interface.

Some examples of the present disclosure relate to a novel App/AAL Broker entity that performs minimal operations (1), (2) and (3), to offload the training of AI/ML application and models from the Near RT-and the Non-RT RIC to the O-Cloud, enabling lower computational load at the RICs and reducing data transmission overhead within O-RAN deployments. Some examples may extend the scope of the O2 interface, dubbed as O2-AAL, to allow RICs to access AAL interface and deploy/execute model training exploiting existing or dynamically instantiated LPUs. Some examples may extend the scope of O1 interface, dubbed as O1-AAL, to enable the exchange of data required by AI/ML models.

Various examples of the present disclosure make use in an opportunistic way of already existing HW accelerator devices to offload high-level AI/ML-model training process from existing training hosts.

Machine learning is a branch of artificial intelligence that involves the development of algorithms and models that allow computers to learn and make predictions or decisions without being explicitly programmed. It focuses on creating systems that can improve their performance over time by learning from data.

Training a machine-learning model refers to the process of teaching the model to make accurate predictions or decisions. During training, the model is exposed to a large amount of data, which is used to adjust the model's internal parameters or weights. The model learns patterns, relationships, or rules from the training data, allowing it to generalize and make predictions on new, unseen data.

Training data is the set of examples or instances that is used to teach a machine-learning model. It is often labeled data, meaning that each example is associated with a known outcome or target value. The training data consists of both input features and the corresponding output or target variable. The model learns from this data by analyzing the patterns and relationships between the input features and the target variable. Training algorithms, such as supervised learning, semi-supervised learning, unsupervised learning or reinforcement learning may be used for training the machine-learning model.

Machine-learning models, such as the machine-learning model being trained in the present disclosure, are often implemented as Artificial Neural Networks (ANNs), and in particular Deep Neural Networks, Support Vector Machines, Decision Tree models, or Random Forest models.

Many modifications and other embodiments of the present disclosure set forth herein will come to mind to the one skilled in the art to which the present disclosure pertains having the benefit of the teachings presented in the foregoing description and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100, 200, 400, 600, 700a/b, 800a/b, 1000 Wireless communication network
110, 210, 410, 610, 710, 810, 1010 Service Management and Orchestration
115, 220, 615, 715, 815, 910, 1015 Non-Real Time RIC
120, 230, 620, 720, 820, 1020 Near Real Time RIC
130, 730, 830, 1030 O-CU-CP
140, 740, 840, 1040 O-CU-UP
330 O-CU
150, 320, 750, 850, 1050 O-DU
160, 310, 760, 860, 1060 O-RU
170, 370, 420, 430, 630, 640, 770, 870, 940, 1070 O-Cloud
650, 780, 880, 920, 1080 App/AAL broker
211 Data collection
212 AI/ML model management
221 Data preparation
222 AI/ML training
223 AI/ML inference
224 AI/ML continuous operation
231 Data collection
232 Data preparation
233 AI/ML inference
340, 423 AAL interface
350 Cloud protocol stack, cloud management, AAL
360 Hardware
421 O-DU application
422 O-CU application
424,632, 950 AAL-LPUs
430 Hardware accelerator device
440, 660, 930 IMS
445, 665, 930 DMS
450, 670 Hardware accelerator manager
510 Provide a request for training an ML model
515 Obtain the request for training the ML model
520 Trigger assignment of computational resources for training application
522 Select/trigger creation of LPU
524 Select/trigger creation of AAL profile
530 Trigger assignment of computational resources for pre-processing application
540 Pre-process data
545 Obtain training data
550 Train the ML model
560 Provide the trained ML model
565 Obtain the trained ML model
960 Processing pipeline application
970 O-Cloud AI/ML application

1. A method for training a machine-learning model for use in a Radio Access Network (RAN) controller of a wireless communication network, the method comprising:
receiving, by a brokering entity from the RAN controller, a request for training the machine-learning model;
triggering, by the brokering entity, an assignment of computational resources of a shared hardware accelerator device being separate from the RAN controller for a training application to be used for training the machine-learning model;
training, by the training application and using the assigned computational resources, the machine-learning model; and
providing the trained machine-learning model to the RAN controller.

2. The method according to claim 1, wherein the shared hardware accelerator device is a used for accelerating at least one function of at least one of a central unit of the wireless communication network and one or more distributed units of the wireless communication network.

3. The method according to claim 2, wherein the at least one function of the central unit and/or the one or more distributed units are prioritized over the training of the machine-learning model during assignment of the computational resources.

4. The method according to claim 1, wherein the wireless communication network is a wireless communication network according to the Open RAN (O-RAN) specification, wherein the RAN controller is one of a O-RAN Near-Real-Time RAN Intelligent Controller and a O-RAN Non-Real-Time RAN Intelligent Controller.

5. The method according to claim 1, wherein triggering assignment of the computational resources comprises selecting or triggering creation of a Logical Processing Unit (LPU) based on the request for training the machine-learning model and based on available computational resources of the shared hardware accelerator device, wherein the machine-learning model is trained using the LPU.

6. The method according to claim 5, wherein the method further comprises triggering, by the brokering entity, creation of a custom LPU for the machine-learning model to be trained.

7. The method according to claim 1, wherein the shared hardware accelerator device is accessible via an Acceleration Abstraction Layer (AAL), wherein the training of the machine-learning model is based on an AAL profile, the AAL profile specifying the training application with one or more accelerated functions to be processed by the shared hardware accelerator device on behalf of the RAN controller, the one or more accelerated functions comprising the training of the machine-learning model.

8. The method according to claim 7, wherein the method further comprises selecting or triggering creation of, by the brokering entity, a pre-defined Logical Processing Unit (LPU) according to a machine-learning model-independent template, or
wherein the method further comprises creating, by the brokering entity, a custom AAL profile for the machine-learning model to be trained based on the request for training the machine-learning model.

9. The method according to claim 1, wherein the method further comprises obtaining, by the training application and based on the request, data to be used for training the machine-learning model from at least one other entity of the wireless communication network.

10. The method according to claim 9, wherein the method further comprises pre-processing, by a pre-processing application being executed using the computational resources of the shared hardware accelerator, the data to be used for training the machine-learning model, with the pre-processed data being used for training the machine-learning model.

11. A wireless communication network comprising:
a Radio Access Network (RAN) controller;
a shared hardware accelerator device being separate from the RAN controller; and
a brokering entity,
wherein the RAN controller is configured to provide a request for training a machine-learning model to the brokering entity,
the brokering entity is configured to trigger an assignment of computational resources of the shared hardware accelerator device for a training application to be used for training the machine-learning model,
the shared hardware accelerator device is configured to execute the training application, and
the RAN controller is configured to obtain the trained machine-learning model from the training application.

12. The wireless communication network according to claim 11, wherein the wireless communication network further comprises a hardware accelerator manager, with the brokering entity being configured to trigger the assignment of the computational resources via the hardware accelerator manager.

13. The wireless communication network according to one of claim 11, wherein the wireless communication network further comprises a first communication interface configured to connect the RAN controller to at least one of a central unit, a distributed unit, and a radio unit of the wireless communication network, and a second communication interface configured to connect the RAN controller to the brokering entity,
wherein the first communication interface may be further configured to connect at least one of the central unit, the distributed unit, and the radio unit to the training application, with the training application being configured to obtain data for training the machine-learning model via the first communication interface.

14. A brokering entity for a wireless communication network, the brokering entity comprising interface circuitry and processing circuitry, wherein the brokering entity is configured to:
obtain, from a Radio Access Network (RAN) controller of the wireless communication network, a request for training a machine-learning model; and
trigger an assignment of computational resources of a shared hardware accelerator device being separate from the RAN controller for a training application to be used for training the machine-learning model.

15. The brokering entity according to claim 14, wherein the brokering entity is configured to trigger an-the assignment of the computational resources of the shared hardware accelerator device for a pre-processing application to be executed using the computational resources of the shared hardware accelerator, wherein the training application is configured to obtain data to be used for training the machine-learning model from the pre-processing application.
